(19) United States
(12) Patent Application Publication
(10) Pub. No.: US 2014/0334851 A1
(43) Pub. Date: Nov. 13, 2014

(54) DEVELOPING APPARATUS AND IMAGE FORMING APPARATUS

(71) Applicants: TOSHIBA TEC KABUSHIKI KAISHA, TOKYO (JP); KABUSHIKI KAISHA TOSHIBA, TOKYO (JP)

(72) Inventor: Takao Izumi, Yokohama-shi (JP)

(73) Assignees: TOSHIBA TEC KABUSHIKI KAISHA, TOKYO (JP); KABUSHIKI KAISHA TOSHIBA, TOKYO (JP)

(21) Appl. No.: 14/228,366

(22) Filed: Mar. 28, 2014

(30) Foreign Application Priority Data
May 7, 2013 (JP) 2013-097562

(51) Int. Cl. G03G 15/09

(52) U.S. Cl. CPC G03G 15/0822
USPC 399/267

(57) ABSTRACT

In accordance with one embodiment, a developing apparatus comprises a developing roller configured to hold developing agent and face to an image carrier; a housing configured to store the developing agent and support the developing roller; and a first gap adjusting section configured inside the housing at the downstream side of an opening end part of the housing in a rotation direction of the developing roller, and configured to protrude from an inner wall of the housing at the side parts in an axis direction of the developing roller.

### CROSS-REFERENCE TO RELATED APPLICATION

This application is based upon and claims the benefit of priority from Japanese Patent Application No. 2013-097562, filed May 7, 2013, the entire contents of which are incorporated herein by reference.

### FIELD

Embodiments described herein relate to a developing apparatus which develops an image using a magnetic brush type developing roller and an image forming apparatus.

### BACKGROUND

In a Multi Function Peripheral (MFP), a printer and the like, there is an apparatus which develops an image using a magnetic brush. In the magnetic brush type developing apparatus, there is an apparatus in which a center gap is made wider than two ends gaps between a developing roller and a developing tank arranged at the downstream side of a nip between the developing roller and a photoconductor for storing the magnetic brush, so as to prevent the toner from scattering.

However, in the magnetic brush type developing apparatus, in a case where the charging ability of the developing agent is decreased, or in a case of a high-speed machine, the toner scatters more easily, therefore, it is preferred to prevent the scattering of toner more reliably.

### BRIEF DESCRIPTION OF THE DRAWINGS

FIG. 1 is a schematic constitution diagram illustrating a MFP according to a first embodiment;

FIG. 2 is a schematic constitution diagram illustrating an image forming station according to the first embodiment;

FIG. 3 is a schematic constitution diagram illustrating a developing apparatus according to the first embodiment;

FIG. 4 is a schematic illustration diagram of a first gap spacer viewed from the side opposite to a developing roller according to the first embodiment;

FIG. 5 is a schematic illustration diagram of the first gap spacer viewed from the side of the developing roller according to the first embodiment;

FIG. 6 is a schematic illustration diagram illustrating a gap between the first gap spacer and the developing roller according to the first embodiment;

FIG. 7 is a schematic illustration diagram illustrating the air flow in a housing caused by the rotation of the developing roller according to the first embodiment;

FIG. 8 is a schematic illustration diagram illustrating the toner adhering to the upper surface of the housing during the rotation of the developing roller according to the first embodiment;

FIG. 9 is a schematic illustration diagram illustrating the toner adhering to the upper surface of the housing during the rotation of the developing roller in an comparison example;

FIG. 10 is a schematic constitution diagram illustrating a developing apparatus according to a second embodiment;

FIG. 11 is a schematic illustration diagram of a first gap spacer and a second gap spacer viewed from the side opposite to a developing roller according to the second embodiment;

FIG. 12 is a schematic illustration diagram of the first gap spacer and the second gap spacer viewed from the side of the developing roller according to the second embodiment;

FIG. 13 is a schematic illustration diagram illustrating a gap between the second gap spacer and the developing roller according to the second embodiment;

FIG. 14 is a schematic illustration diagram illustrating the air flow in a housing caused by the rotation of the developing roller according to the second embodiment;

FIG. 15 is a schematic illustration diagram illustrating the toner adhering to the upper surface of the housing during the rotation of the developing roller according to the second embodiment;

FIG. 16 is a schematic illustration diagram of a first gap spacer, a second gap spacer and a third gap spacer viewed from the side opposite to a developing roller according to a first modification;

FIG. 17 is a schematic illustration diagram of the first gap spacer, the second gap spacer and the third gap spacer viewed from the side of the developing roller according to the first modification;

FIG. 18 is a schematic illustration diagram illustrating a gap between the second gap spacer, the third gap spacer and the developing roller according to the first modification;

FIG. 19 is a schematic illustration diagram of a first gap spacer, a second gap spacer and a third gap spacer viewed from the side opposite to a developing roller according to a second modification; and

FIG. 20 is a schematic illustration diagram illustrating the toner adhering to the upper surface of a housing during the rotation of the developing roller according to the second modification.

### DETAILED DESCRIPTION

In accordance with one embodiment, a developing apparatus comprises a developing roller configured to hold developing agent and face to an image carrier; a housing configured to store the developing agent and support the developing roller; and a first gap adjusting section configured inside the housing at the downstream side of an opening end part of the housing in a rotation direction of the developing roller, and configured to protrude from an inner wall of the housing at the side parts in an axis direction of the developing roller.

The embodiment is described below.

### A First Embodiment

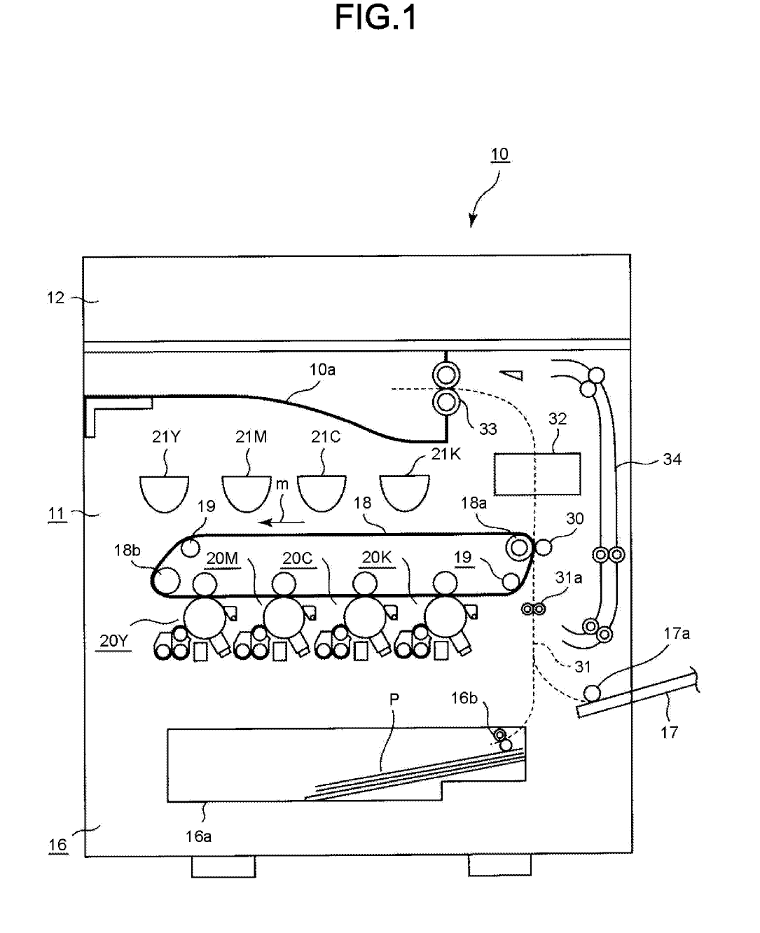

An image forming apparatus according to the first embodiment is described with reference to FIG. 1-FIG. 9. FIG. 1 shows a color MFP (Multi-Function Peripherals) 10 as one example of the image forming apparatus according to the first embodiment. A MFP 10 is provided with a printer section 11, a scanner section 12 and a paper feed cassette section 16.

The paper feed cassette section 16 comprises a paper feed cassette 16a for storing a sheet P and a pickup roller 16b for taking the sheet Pout of the paper feed cassette 16a. The paper feed cassette 16a is capable of feeding a new sheet (unused sheet) or a reusable sheet (for example, a sheet the image on which is erased) and the like. The MFP 10 further comprises a manual paper feed tray 17 which feeds a sheet using a pickup roller 17a.

The printer section 11 comprises yellow (Y), magenta (M), cyan (C) and black (K) image forming stations 22Y, 22M, 22C and 22K which are arranged in parallel below an intermediate transfer belt 18 which rotates in a direction indicated by an arrow m. The printer section 11 comprises replenishing cartridges 21Y, 21M, 21C and 21K above each of the image forming stations 20Y, 20M, 20C and 20K, respectively.

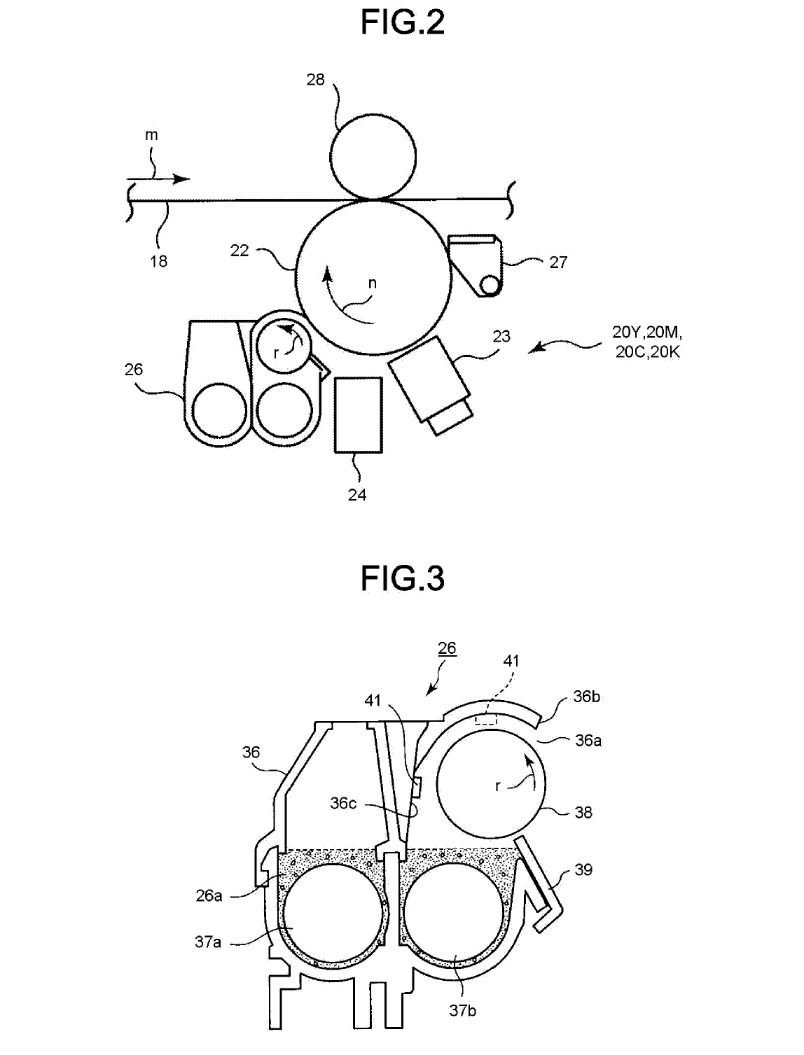

The four image forming stations 20Y, 20M, 20C and 20K are described in detail. The four image forming stations 20Y, 20M, 20C and 20K with the same constitutions are described with reference to FIG. 2 using common reference marks. Each image forming station 20Y, 20M, 20C and 20K is provided with an electric charger 23, an exposure scanning head 24, a developing apparatus 26 and a photoconductor cleaner 27 around a photosensitive drum 22 which serves as an image carrier and rotates in a direction indicated by an arrow n.

Each image forming station 20Y, 20M, 20C and 20K exposes, using the exposure scanning head 24, the photoconductive drum 22 uniformly charged by the electric charger 23, so as to form an electrostatic latent image on the photoconductive drum 22. The developing apparatus 26 supplies toner serving as developing agent for the photosensitive drum 22 to visualize the electrostatic latent image. The photosensitive drum 22, the electric charger 23 and the exposure scanning head 24 constitute an image forming section.

Each image forming station 20Y, 20M, 20C and 20K is provided with a primary transfer roller 28 across the intermediate transfer belt 18 which rotates in the direction indicated by the arrow m under the driving of a backup roller 18a, a driven roller 18b and a tension roller 19. The primary transfer roller primarily transfers a toner image formed on the photosensitive drum 22 to the intermediate transfer belt 18. The primary transfer roller 28 of each image forming station 20Y, 20M, 20C and 20K superimposes the Y (yellow), M (magenta), C (cyan) and K (black) toner images on the intermediate transfer belt 18 in sequence to form color toner images. The photoconductor cleaner 27 removes the toner left on the photoconductive drum 22 after the primary transfer.

A secondary transfer roller 30, which is positioned opposite to the backup roller 18a across the intermediate transfer belt 18, is driven to rotate by the intermediate transfer belt 18. The secondary transfer roller 30 secondarily transfers all the color toner images on the intermediate transfer belt 18 to the sheet P fed from the paper feed cassette 16a or the manual paper feed tray 17 along a conveyance path 31.

The replenishing cartridges 21Y, 21M, 21C and 21K replenish the developing apparatuses 26 of the image forming stations 20Y, 20M, 20C and 20K with toner, respectively, as the toner in the developing apparatuses 26 is consumed.

The printer section 11 comprises a register roller 31a along the conveyance path 31, and the printer section 11 further comprises a fixing device 32 and paper discharge roller pairs 33 at the downstream side of the secondary transfer roller 30. The printer section 11 comprises a reversal conveyance section 34 at the downstream side of the fixing device 32.

With these constitutions, the MFP 10 forms color toner images on the sheet P using the printer section 11 and then discharges the sheet to a paper discharge section 10a. The image forming apparatus is not limited to the MFP 10. The image forming apparatus may be a monochrome image forming apparatus, and the number of the image forming stations is not limited. The image forming apparatus may directly transfer the toner image to the sheet from the photoconductor. Further, the image forming apparatus may also include a plurality of printer sections.

The developing apparatus 26 of each image forming station 20Y, 20M, 20C and 20K is described in detail. The developing apparatus 26 of each image forming station 20Y, 20M, 20C and 20K develops the electrostatic latent image on the photosensitive drum 22 using two-component developing agent including Y (yellow), M (magenta), C (cyan) or K (black) toner and carrier, respectively.

As shown in FIG. 3-FIG. 6, the developing apparatus 26 comprises a stirring auger 37a, a conveyance auger 37b, and the developing roller 38 which rotates in a direction indicated by an arrow r inside a housing 36 for storing developing agent 26a. The stirring auger 37a and the conveyance auger 37b stir the developing agent 26a in the housing 36 and supply the developing agent 26a for the developing roller 38.

The developing agent 26a of each image forming station 20Y, 20M, 20C and 20K is the two-component developing agent including Y (yellow), M (magenta), C (cyan) or K (black) toner and carrier, respectively. The toner may be, for example, color inerasable toner or color erasable toner.

The color erasable toner is, for example, the toner the color of which can be erased when being heated to a temperature above a given color erasing temperature. The color erasable toner is formed by, for example, adding color material to binder resin. The color material includes a color generation compound, a color developing agent and a color erasing agent at least. If needed, the color material may also be selectively prepared by properly adding and using discoloration temperature adjusting agent and the like so that the generated color is erased at a temperature above a certain temperature. If the toner image formed with the color erasable toner is heated to a temperature above a given color erasing temperature, the interaction of the color generation compound and the color developing agent in the color erasable toner is eliminated, and therefore, the color of the toner image is erased.

As the color generation compound constituting the color material, for example, the well-known leuco dye such as diphenylmethanephthalides is generally used. The leuco dye is an electron releasing compound which can generate color under the effect of the color developing agent.

The color developing agent constituting the color material is, for example, an electron-accepting compound, which endows the leuco dye with protons, such as phenols, metal salts of phenols and the like.

The color erasing agent constituting the color material may be any well-known material that can hinder the color generation reaction of the color generation compound and the color developing agent by heating in a three-component system consisting of the color generation compound, the color developing agent and the color erasing agent to make the system colorless. The color erasing agent (for example, alcohols, esters and the like) using temperature hysteresis is outstanding in instant color-erasing property as a generated color erasing mechanism. In the generated color erasing mechanism using temperature hysteresis, a color-erasable toner the color of which is developed can be erased after being heated to a temperature above a given color erasing temperature. For example, the color-erasable toner can be fixed on a sheet at a relatively low temperature and be erased at a temperature which is, for example, 10 degrees centigrade higher than the fixing temperature.

The binder resin may be any kind of resin that has a low melting point or a low glass transition point temperature Tg so that the resin can be fixed at a temperature lower than the color erasing temperature of the matched color material. The binder resin may be, for example, polyester resin, polystyrene resin and the like. The binder resins may be properly selected corresponding to the matched color material.

The housing 36 of the developing apparatus 26 has an opening 36a where part of the developing roller 38 is exposed. The developing roller 38 faces to the photosensitive drum 22 at the position of the opening 36a. The housing 36 comprises a layer thickness regulating member 39 at the opening 36a. The layer thickness regulating member 39 regulates the thickness of the magnetic brush shaped developing agent layer formed around the developing roller 38. The housing 36 further comprises, inside the housing at the downstream side of an opening end part 36b in the rotation direction of the developing roller 38, a first gap spacer 41 serving as a first gap adjusting section which protrudes from an inner wall 36c opposite to the developing roller 38.

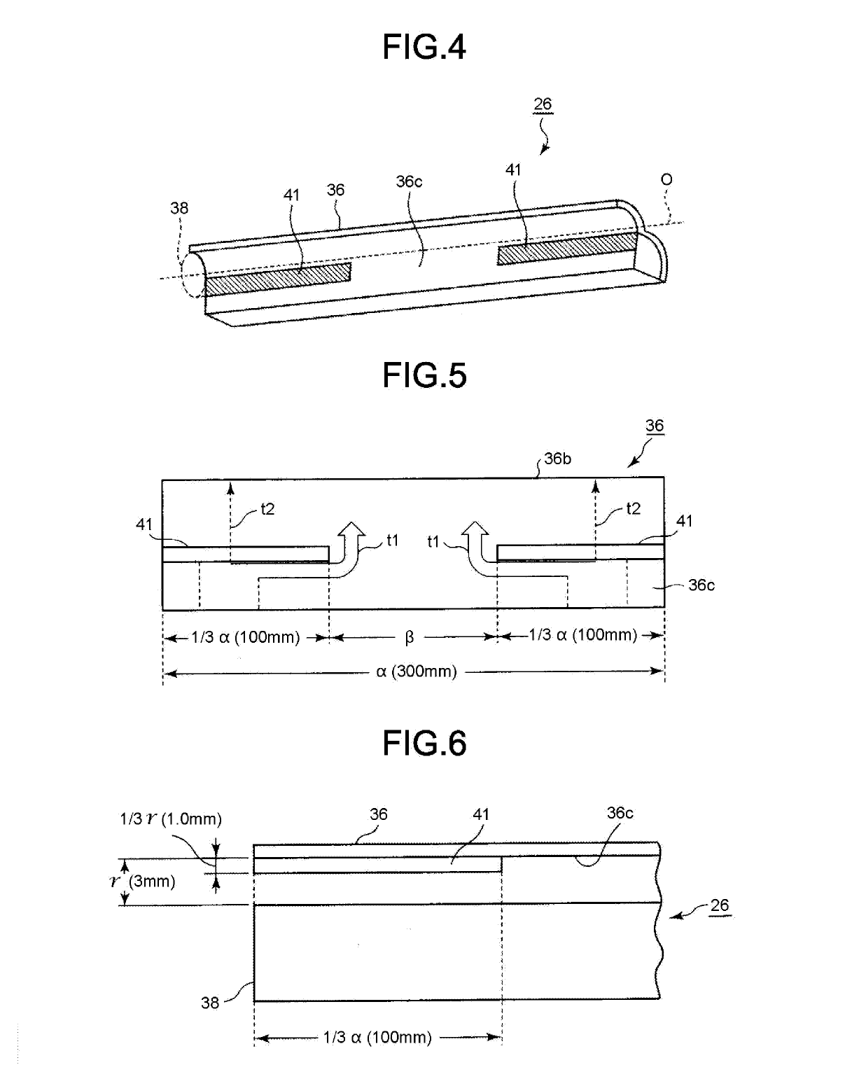

As shown in FIG. 4, the first gap spacer 41 is at the two sides of the inner wall 36c in the direction of an axis o of the developing roller 38. As shown in FIG. 5, the width of the first gap spacer 41 in the direction of the axis o of the developing roller 38 is one third of the developing roller width α. The width of the first gap spacer 41 is not limited.

The length of an air flow reduction area for reducing the air flow flowing out form two ends in the direction of the axis o of the developing roller 38, and the length of a scattered toner reduction area for reducing the scattered toner at two ends of the developing apparatus 26 are increased as the length of the first gap spacer 41 increases. On the other hand, in order to make more air flow out from a center part β in the direction of the axis o of the developing roller 38 and to reduce the scattered toner at two ends, the width of the center part β is preferred to be long. Thus, in order to reduce the scattered toner at the two ends of the developing apparatus 26 and to make more air flow out from the center part β, it is preferred to make the width of the first gap spacer 41 one third or less than one third of the developing roller width α.

The thickness of the first gap spacer 41 is one third of a gap γ between the developing roller 38 and the inner wall 36c of the housing 36 at the center part β in the direction of the axis o of the developing roller 38 shown in FIG. 6. The thickness of the first gap spacer 41 is not limited. In order to make the air flow out more easily from the center part β so as to reduce the air flow at the two sides in the direction of the axis o of the developing roller 38, it is preferred to make the thickness of the first gap spacer 41 one third or less than one third of the gap γ at the center part β. For example, if the width of the developing roller 38 is 300 mm, and the gap between the developing roller 38 and the inner wall 36c of the housing 36 is 3 mm, it is preferred that the width of the first gap spacer 41 is 100 mm, and the thickness of the first gap spacer 41 is 1.0 mm.

During an image developing process, the thickness of the developing agent 26a around the developing roller 38 rotating in the direction indicated by the arrow r is regulated by the layer thickness regulating member 39, and the developing roller visualizes the electrostatic latent image on the photosensitive drum 22. The developing agent 26a, which is still left on the developing roller 38 after passing through the facing position with the photosensitive drum 22, is collected in the housing 36.

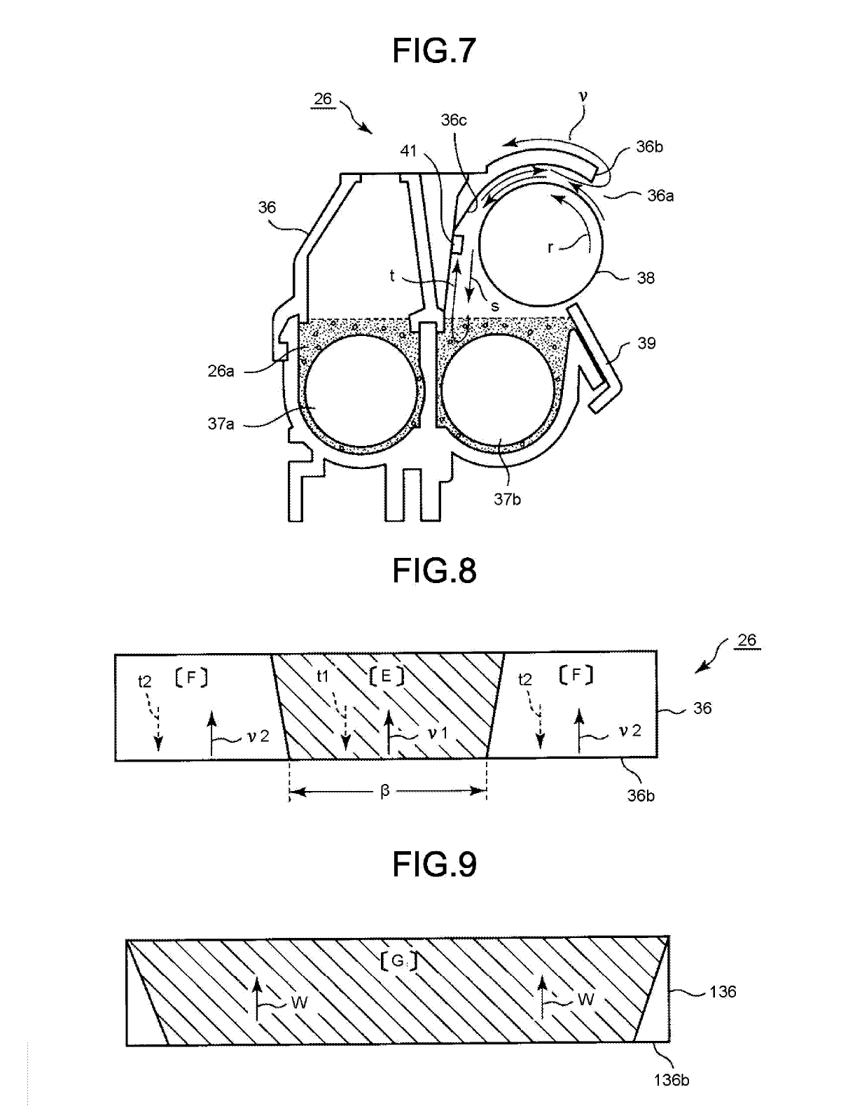

As shown in FIG. 7, air flow s flowing into the housing 36 in the same direction as the rotation direction of the developing roller 38 is caused in the housing 36 as the developing roller 38 rotates in the direction indicated by the arrow r. If the air flow s flows into the housing 36 and the air pressure inside the housing 36 is higher than that outside the housing 36, air flow t flowing towards the direction of the opening 36a almost having no resistance is generated in the housing 36. The air flow t blows the floating toner separating from the carrier in the housing 36, and becomes air flow v flowing towards space above the housing 36 from the opening end part 36b of the housing 36, which scatters the toner all around.

The strength of the air flow t which blows the floating toner and flows towards the opening 36a from the housing 36 meets the following condition: t1>t2, as shown in FIG. 5. The air flow t1 flows out from the center part β of the developing roller 38. The air flow t2 passes through the gap between the first gap spacer 41 and the developing roller 38 and flows out from the two sides of the developing roller 38. Most of the air flow t flows out from the center part β where the gap between the developing roller 38 and the inner wall 36c of the housing 36 is large. The air flow t is reduced at the two sides of the developing roller 38 where the gap between the developing roller 38 and the inner wall 36c of the housing 36 is narrowed by the first gap spacer 41.

The adhesion of the scattered toner brought by the air flow v flowing out from the housing 36 during the rotation of the developing roller 38 to the upper surface of the housing 36 is shown in FIG. 8. In an area [E] indicated by oblique lines corresponding to the center part β of the upper surface of the housing 36, a lot of air flow v1 resulting from the air flow t1 flows out from the opening end part 36b, therefore, a lot of toner adheres to the upper surface of the housing 36. In areas [F] at the two sides of the developing roller 38, a small quantity of toner adheres to the upper surface of the housing 36 as the air flow v2 which results from the air flow t2 and flows out from the opening end part 36b is reduced.

As a comparison example, in a developing apparatus provided with no first gap spacer 41, the air flow flowing out from a front end part 136b of a housing 136 in a direction indicated by an arrow w is almost the same from the center part to the end parts in a longitudinal direction of the housing 136. The amount of the scattered toner adhering to the upper surface of the housing 136 in the comparison example is almost the same in an area [G] indicated by oblique lines in FIG. 9. In the comparison example, from the center part to the end parts in the longitudinal direction of the housing 136, the toner adheres to almost the whole upper surface of the housing 136 uniformly.

In the comparison example, almost the whole area in the longitudinal direction, including the end parts of the developing apparatus, is covered by the scattered toner. In the comparison example, the scattered toner floating from the end parts of the developing apparatus to the space around the apparatus soils the end parts of the devices around the developing apparatus such as the electric charger or the primary transfer roller, or the like. On the contrary, in the first embodiment, as there is little scattered toner at the two ends of the developing apparatus 26, therefore there is no risk that the end parts of the devices around the developing apparatus 26 are soiled.

No specific limitation is given to the arrangement position of the first gap spacer 41 in the housing 36 in the first embodiment as long as the toner which is brought by the air flow v flowing out from the housing 36 and adheres to the end parts of the housing 36 can be reduced. For example, the first gap spacer 41 may be arranged at a position near the opening 36a of the housing 36 as shown by the dotted lines in FIG. 3.

In accordance with the first embodiment, the first gap spacer 41 is arranged at the two sides of the inner wall 36c of the housing 36. The gap between the developing roller 38 and the inner wall 36c of the housing 36 at the center part β of the developing roller 38 is made wide, and the gap between the developing roller 38 and the first gap spacer 41 at the two sides of the developing roller 38 is narrowed. The air flow t1 flowing from the housing 36 towards the opening 36a at the center part β of the developing roller 38 is increased, and the air flow t2 flowing from the housing 36 towards the opening 36a at the two sides of the developing roller 38 is reduced. The developing apparatus 26 reduces the air flow v2 flowing out from the opening end part 36b of the housing 36 at the two ends of the housing 36, so as to reduce the scattered toner in the two end areas [F] of the housing 36. The developing apparatus 26 reduces the scattered toner from the end parts, which prevents the devices around the developing apparatus 26 from being soiled during the rotation of the developing roller 38. In accordance with the first embodiment, image defects caused by the scattered toner from the end parts of the developing apparatus 26 can be prevented and a printed image with good quality can be achieved.

According to the first embodiment, by making the width of the first gap spacer 41 less than one third of the width of the developing roller 38, the air flow t1 from the center part β of the developing roller 38 can flow out smoothly, which restricts the flowing out of the air flow t2 from two sides, and reduces the scattered toner from the end parts of the developing apparatus 26.

### A Second Embodiment

The image forming apparatus according to the second embodiment is described with reference to FIG. 10-FIG. 15. The structure of the gap adjusting section in the second embodiment is different from that in the first embodiment. Components in the second embodiment similar to those described in the first embodiment are endowed with the same reference numerals, and therefore, the detailed descriptions thereof are not repeated.

As shown in FIG. 10, the housing 36 of a developing apparatus 46 further comprises a second gap spacer 42 serving as a second gap adjusting section which protrudes from the inner wall 36c of the housing 36. The second gap spacer 42 is at the upstream side of the first gap spacer 41 in the rotation direction of the developing roller 38, that is, the direction indicated by the arrow r.

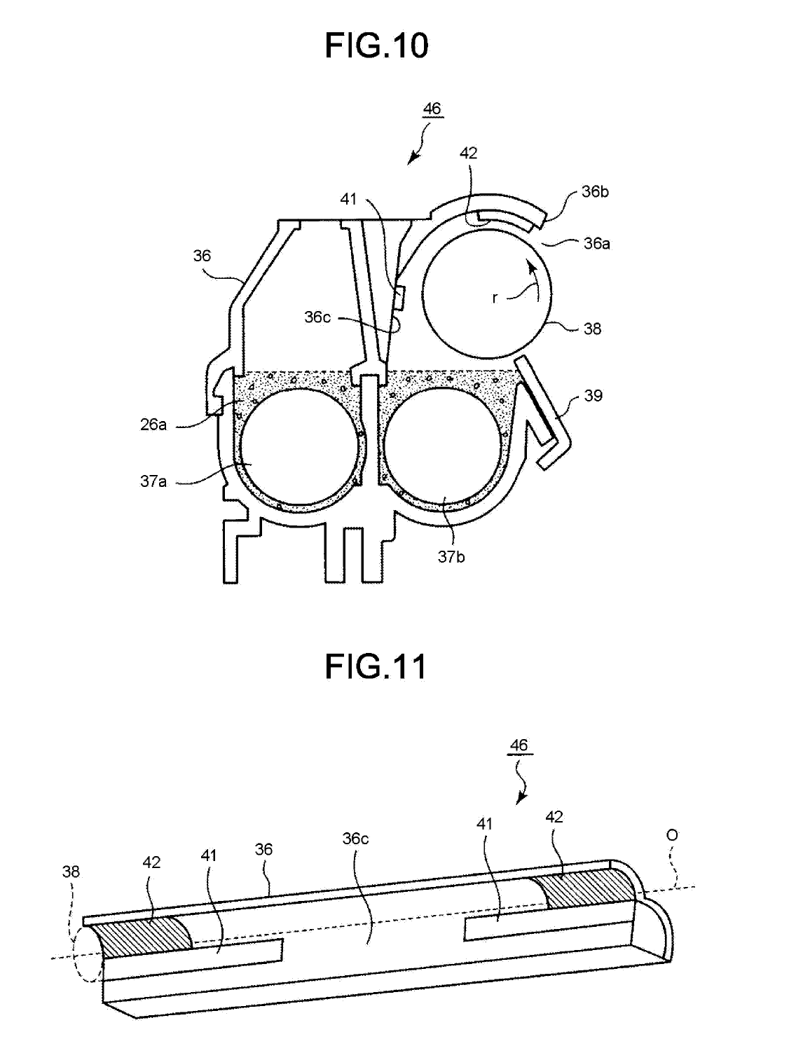

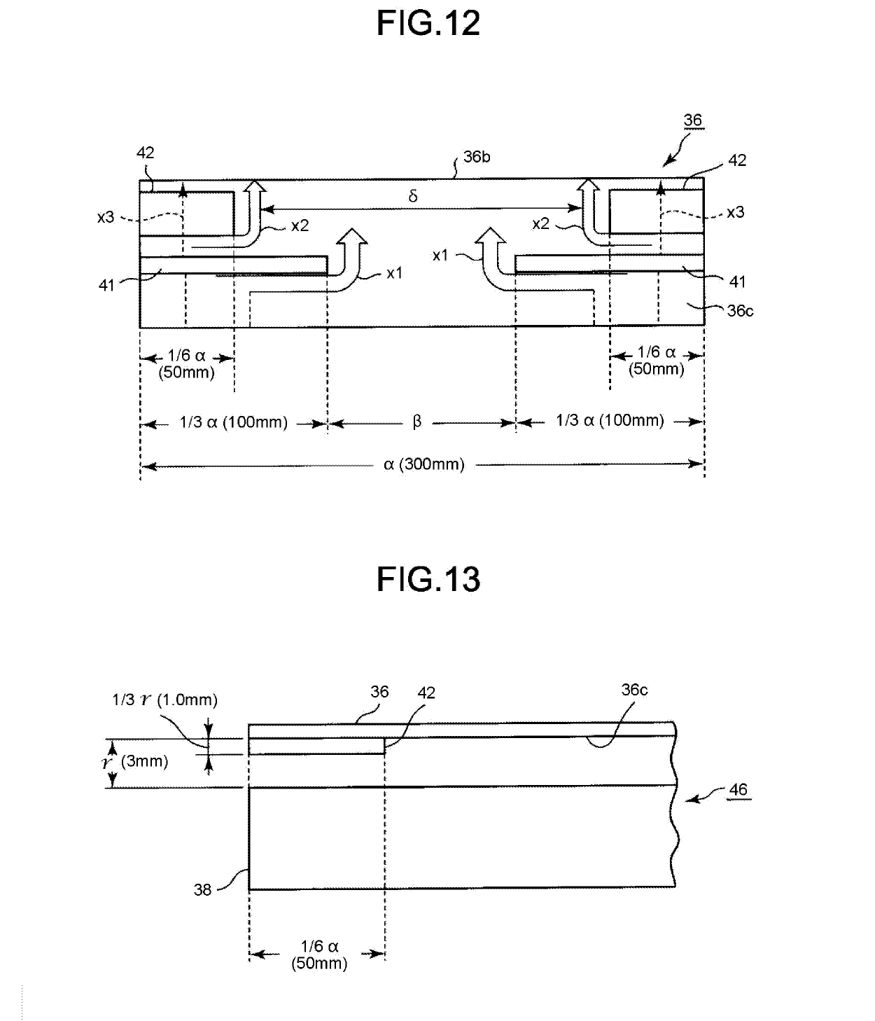

As shown in FIG. 11, the second gap spacer 42 is at the two sides of the inner wall 36c in the direction of an axis o of the developing roller 38. As shown in FIG. 12, the width of the second gap spacer 42 in the direction of the axis o of the developing roller 38 is one half of the width of the first gap spacer 41. The width of the second gap spacer 42 is not limited. In order to make the air flow out more easily from the center part β so as to reduce the air flow at the two sides in the direction of the axis o of the developing roller 38, it is preferred to make the width of the second gap spacer 42 one half or less than one half of the width of the first gap spacer 41. For example, if the width of the first gap spacer 41 is 100 mm, it is preferred that the width of the second gap spacer 42 is 50 mm.

The thickness of the second gap spacer 42 is one third of a gap γ between the developing roller 38 and the inner wall 36c of the housing 36 at the center part β in the direction of the axis o of the developing roller 38 shown in FIG. 13. The thickness of the second gap spacer 42 is not limited. In order to make the air flow out more easily from the center part β so as to reduce the air flow at the two sides in the direction of the axis o of the developing roller 38, it is preferred to make the thickness of the second gap spacer 42 one third or less than one third of the gap γ at the center part β. For example, if the gap between the developing roller 38 and the inner wall 36c of the housing 36 at the center part β is 3 mm, it is preferred that the thickness of the second gap spacer 42 is 1.0 mm.

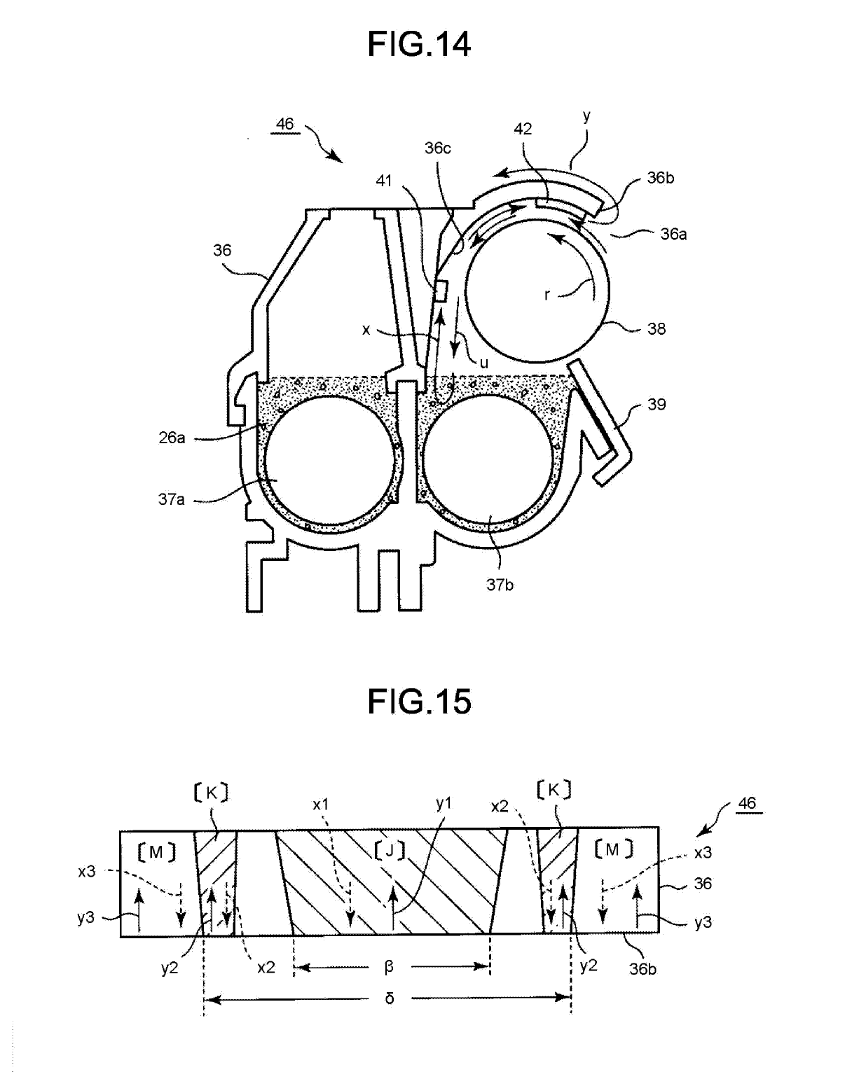

During an image developing process, as shown in FIG. 14, air flow u flowing into the housing 36 is generated in the housing 36 as the developing roller 38 rotates in the direction indicated by the arrow r. Further, air flow x which blows the floating toner and flows from the inside of the housing 36 towards the direction of the opening 36a is generated in the housing 36. The air flow x becomes air flow y flowing towards space above the housing 36 from the opening end part 36b of the housing 36, which scatters the toner all around.

The strength of the air flow x which blows the floating toner and flows towards the opening 36a from the housing 36 meets the following condition: x1>x2>x3, as shown in FIG. 12. The air flow x1 flows out from the center part β of the developing roller 38 at the position of the first gap spacer 41. The air flow x2 flows out from the space between the first gap spacer 41 and the second gap spacer 42. The air flow x3 flows out from the two sides of the developing roller 38.

Most of the air flow x flows out from the center part β where the gap between the developing roller 38 and the inner wall 36c of the housing 36 is large at the position of the first gap spacer 41. A relatively large quantity of air flow x flows out from a center part 5 where the gap between the developing roller 38 and the inner wall 36c of the housing 36 is large at the position of the second gap spacer 42. Further, a small amount of air flow x passes through the gap between the first gap spacer 41 and the developing roller 38 and the gap between the second gap spacer 42 and the developing roller 38, and flows out from the two sides of the developing roller 38.

The adhesion of the scattered toner brought by the air flow y flowing out from the housing 36 during the rotation of the developing roller 38 to the upper surface of the housing 36 is shown in FIG. 15. In an area [J] indicated by oblique lines corresponding to the center part β of the upper surface of the housing 36, a lot of toner brought by the air flow y1 which results from the air flow x1 and flows out from the opening end part 36b adheres to the upper surface of the housing 36. In areas [K] indicated by oblique lines at the two sides of the center part 5 of the housing 36, a relatively large quantity of toner brought by the air flow y2 which results from the air flow x2 and flows out from the opening end part 36b adheres to the upper surface of the housing 36. At the two ends [M] of the upper surface of the housing 36, a small quantity of toner brought by the air flow y3 which results from the air flow x3 passing through the gap between the second gap spacer 42 and the developing roller 38 and flows out from the opening end part 36b adheres to the upper surface of the housing 36.

In the second embodiment, most of the air flow passing through the gap between the first gap spacer 41 and the developing roller 38 is further made to flow in the direction of the center part δ of the developing roller 38 by the second gap spacer 42. In the second embodiment, the toner scattering at the two ends [M] of the housing 36 can be reduced in two stages by the first gap spacer 41 and the second gap spacer 42. The scattered toner at the end parts of the developing apparatus 46 is reduced, and therefore, the devices around the developing apparatus 46 will not be soiled.

No specific limitation is given to the arrangement positions of the first gap spacer 41 and the second gap spacer 42 in the housing 36 in the second embodiment as long as the toner which is brought by the air flow y flowing out from the housing 36 and adheres to the end parts of the housing 36 can be reduced. For example, the first gap spacer 41 and the second gap spacer 42 may be arranged closer to each other. Further, a plurality of second gap spacers 42 may be arranged in the rotation direction of the developing roller 38.

In accordance with the second embodiment, the first gap spacer 41 is arranged at the two sides of the inner wall 36c of the housing 36. Further, the second gap spacer 42 is arranged at the two sides of the inner wall 36c of the housing 36 at the upstream side of the first gap spacer 41 in the rotation direction of the developing roller 38. The gap between the developing roller 38 and the inner wall 36c of the housing 36 at the center part β of the developing roller 38 is made wide, and therefore the air flow x1 flowing from the housing 36 towards the opening 36a at the center part β of the developing roller 38 is increased. The gap between the developing roller 38 and the inner wall 36c of the housing 36 at the center part 5 of the developing roller 38 is made wide, and therefore the air flow x2 flowing from the housing 36 towards the opening 36a through the area between the first gap spacer 41 and the second gap spacer 42 is increased to a relatively large quantity. The air flow x3 flowing from the housing 36 towards the opening 36a at the two sides of the developing roller 38 is reduced.

The developing apparatus 46 more reliably reduces the scattered toner from the end parts of the developing apparatus 46 using the first gap spacer 41 and the second gap spacer 42. In accordance with the second embodiment, even in a MFP 10 with high speed, the devices around the developing apparatus 46 can be prevented from being soiled, and image defects caused by the scattered toner from the end parts of the developing apparatus 46 can be prevented, thereby achieving a printed image with good quality.

According to the second embodiment, by making the width of the second gap spacer 42 one half of the width of the first gap spacer 41, the air flow x1 and x2 from the center part δ can flow out smoothly at the upstream side of the rotation direction of the developing roller 38, which restricts the flowing out of the air flow x3 from two sides, and more reliably reduces the scattered toner from the end parts of the developing apparatus 46.

In accordance with at least one of the embodiments described above, the scattering of toner from the end parts of the developing apparatus in the axis direction of the developing roller is prevented. Thus, the devices around the developing apparatus are prevented from being soiled by the scattered toner, thereby achieving printed images with good quality.

In the image forming apparatus according to at least one of the embodiments described above, the size or the shape and the like of the first gap adjusting section or the second gap adjusting section is not limited. For example, the first gap adjusting section or the second gap adjusting section may be formed separately from the housing and is attached to the inner wall of the housing. Alternatively, the first gap adjusting section or the second gap adjusting section may also be integrally formed on the housing.

In a case of desiring to prevent scattered toner at one side end part of the developing apparatus, the first gap adjusting section or the second gap adjusting section may be arranged only at the side where the user desires to prevent the scattered toner.

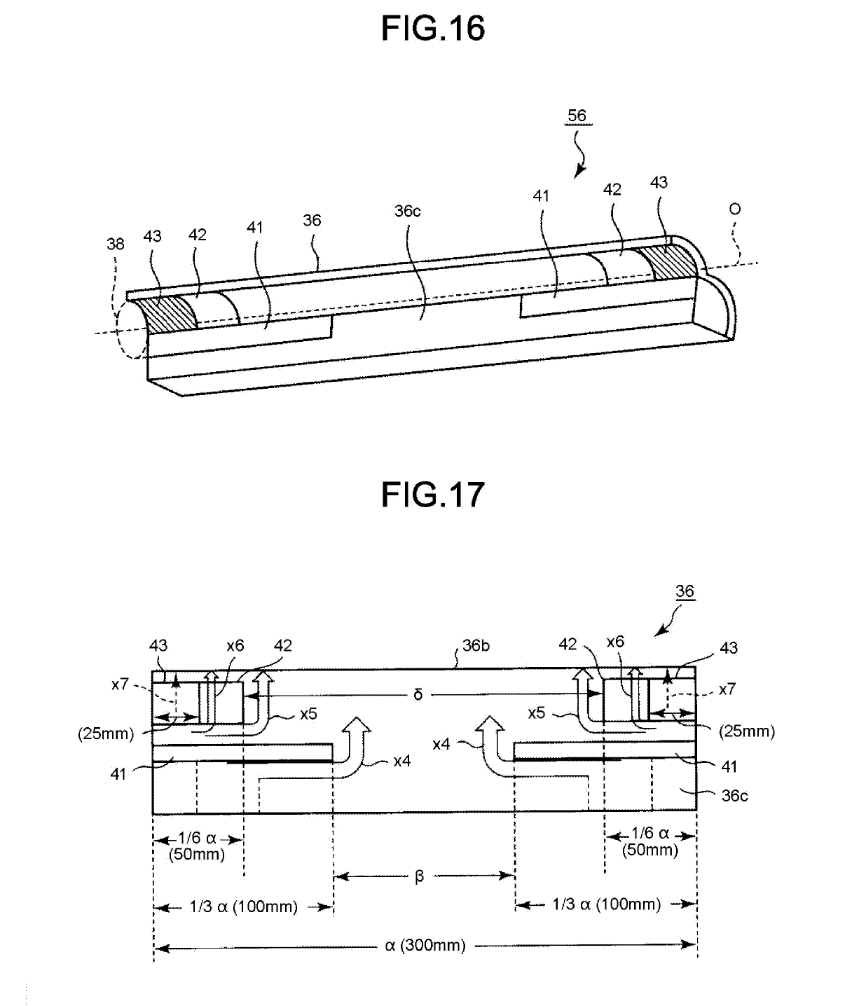

Further, for example, the second gap adjusting section in the second embodiment may be structured in multi-stages as shown by a developing apparatus 56 of a first modification shown in FIG. 16-FIG. 18. In the developing apparatus 56, the second gap adjusting section further includes a third gap spacer 43, in addition to the second gap spacer 42.

The width of the third gap spacer 43 in the direction of the axis o of the developing roller 38 is one half of the width of the second gap spacer 42. The width of the third gap spacer 43 is not limited. In order to make the air flow out more easily from the center part 6 so as to reduce the air flow at the two sides in the direction of the axis o of the developing roller 38, it is preferred to make the width of the third gap spacer 43 one half or less than one half of the width of the second gap spacer 42. For example, if the width of the second gap spacer 42 is 50 mm, it is preferred that the width of the third gap spacer 43 is 25 mm.

The sum of the thickness of the second gap spacer 42 and the thickness of the third gap spacer 43 is one half of a gap γ between the developing roller 38 and the inner wall 36c of the housing 36 at the center part β in the direction of the axis o of the developing roller 38. The sum of the thickness of the second gap spacer 42 and the thickness of the third gap spacer 43 is not limited. In order to make the air flow out more easily from the center part β so as to reduce the air flow at the two sides in the direction of the axis o of the developing roller 38, it is preferred to make the sum of the thickness of the second gap spacer 42 and the thickness of the third gap spacer 43 one half or less than one half of the gap γ at the center part β. For example, as shown in FIG. 18, if the gap between the developing roller 38 and the inner wall 36c of the housing 36 at the center part β is 3 mm, and the thickness of the second gap spacer 42 is 1.0 mm, it is preferred that the thickness of the third gap spacer 43 is 0.5 mm.

In the developing apparatus 56, the strength of the air flow x which blows the floating toner and flows towards the opening 36a from the housing 36 as the developing roller 38 rotates in the direction indicated by the arrow r meets the following condition: x4>x5>x6>x7, as shown in FIG. 17. The air flow x4 flows out from the center part β of the developing roller 38 at the position of the first gap spacer 41. The air flow x5 flows out from the space between the first gap spacer 41 and the second gap spacer 42. The air flow x6 flows out from the space between the end part of the second gap spacer 42 and the end part of the third gap spacer 43. The air flow x7 flows out from the two sides of the developing roller 38.

In the developing apparatus 56, most of the air flow x flows out from the center part β where the gap between the developing roller 38 and the inner wall 36c of the housing 36 is large at the position of the first gap spacer 41. A relatively large quantity of air flow x flows out from the center part 6 where the gap between the developing roller 38 and the inner wall 36c of the housing 36 is large at the position of the second gap spacer 42. A relatively small amount of air flow x passes through the gap between the first gap spacer 41 and the developing roller 38 and the gap between the second gap spacer 42 and the developing roller 38, and flows out at the position of the second gap spacer 42. Further, a small amount of air flow x passes through the gap between the first gap spacer 41 and the developing roller 38 and the gap between the third gap spacer 43 and the developing roller 38, and flows out from the two ends of the developing roller 38.

In the first modification, during the rotation of the developing roller 38, the air flow x7 flowing towards the opening end part 36b at the two ends of the developing apparatus 56 is reduced in two stages by the first gap spacer 41 and the third gap spacer 43. In the first modification, the scattered toner at the end parts of the developing apparatus 56 is reduced, and therefore, the devices around the developing apparatus 56 are prevented from being soiled by the scattered toner floating from the end parts of the developing apparatus 56 to the space around the apparatus.

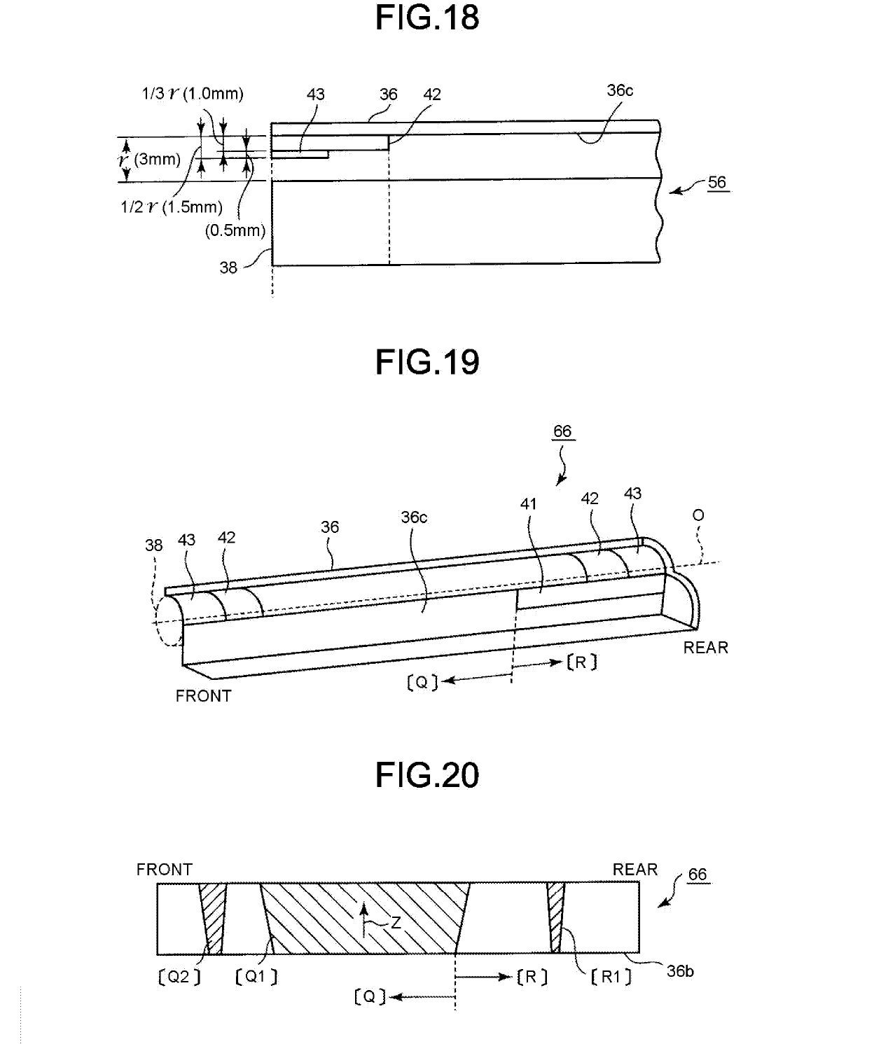

As a second modification, the first gap spacer 41 in the first modification may be arranged only at one side of the developing apparatus. As shown in FIG. 19, the developing apparatus 66 according to the second modification is only provided with one first gap spacer 41 at the rear side of the developing apparatus 66. In the second modification, the air flow, which blows the floating toner and flows out from the opening end part 36b of the housing 36 as the developing roller 38 rotates to develop an image, flowing in a rear side area [R] is less than that flowing in a front side area [Q].

In the second modification, the adhesion of the scattered toner brought by the air flow z flowing out from the opening end part 36b of the housing 36 during the rotation of the developing roller 38 to the upper surface of the housing 36 is shown in FIG. 20. In an area [Q1] at the front side of the upper surface of the housing 36 where no gap spacer is arranged, a lot of toner brought by the air flow z flowing out from the opening end part 36b adheres to the upper surface of the housing 36. In an area [Q2] at the front side where the second gap spacer 42 and the third gap spacer 43 are arranged, the toner brought by the air flow z passing through the second gap spacer 42 and the third gap spacer 43 adheres to the upper surface of the housing 36. In an area [R1] at the rear side [R] of the upper surface of the housing 36 nearby the end part of the second gap spacer 42, the toner brought by the air flow z passing through the first gap spacer 41 adheres to the upper surface of the housing 36.

In the second modification, the scattered toner at the two sides of the developing apparatus 66 is reduced by the second gap spacer 42 and the third gap spacer 43, which prevents the devices around the developing apparatus 66 from being soiled. Further, in the second modification, the first gap spacer 41 is arranged only at the rear side of the developing apparatus 66, and more air flow z is made to flow through the front side area [Q] of the developing apparatus 66, compared with the rear side area [R] of the developing apparatus 66. The risk of being soiled by the scattered toner at the rear side [R] of the developing apparatus 66 is reduced. For example, the maintenance can be improved by reducing the scattered toner at the rear side [R].

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A developing apparatus, comprising:
a developing roller configured to hold developing agent and face to an image carrier;
a housing configured to store the developing agent and support the developing roller; and
a first gap adjusting section configured inside the housing at the downstream side of an opening end part of the housing in a rotation direction of the developing roller, and configured to protrude from an inner wall of the housing at the side parts in an axis direction of the developing roller.

2. The developing apparatus according to claim 1, wherein
the width of the first gap adjusting section in the axis direction of the developing roller is less than one third of the width of the developing roller.

3. The developing apparatus according to claim 1, wherein
the thickness of the first gap adjusting section is less than one third of a gap between the developing roller and the inner wall of the housing at a center part in the axis direction of the developing roller.

4. A developing apparatus, comprising:
a developing roller configured to hold developing agent and face to an image carrier;
a housing configured to store the developing agent and support the developing roller;
a first gap adjusting section configured inside the housing at the downstream side of an opening end part of the housing in a rotation direction of the developing roller, and configured to protrude from an inner wall of the housing at the side parts in an axis direction of the developing roller; and
a second gap adjusting section configured at the upstream side of the first gap adjusting section in the rotation direction of the developing roller, and configured to protrude from the inner wall of the housing at the side parts in the axis direction of the developing roller.

5. The developing apparatus according to claim 4, wherein
the width of the second gap adjusting section in the axis direction of the developing roller is shorter than the width of the first gap adjusting section.

6. The developing apparatus according to claim 4, wherein
the width of the first gap adjusting section in the axis direction of the developing roller is less than one third of the width of the developing roller.

7. The developing apparatus according to claim 4, wherein
the thickness of the second gap adjusting section at the side of side parts is thicker than that at the side of the center in the axis direction of the developing roller.

8. The developing apparatus according to claim 4, wherein
the thickness of the first gap adjusting section is less than one third of a gap between the developing roller and the inner wall of the housing at the center part in the axis direction of the developing roller; and
the thickness of the second gap adjusting section at the side of the center in the axis direction of the developing roller is less than one third of the gap between the developing roller and the inner wall of the housing at the center part in the axis direction of the developing roller.

9. An image forming apparatus, comprising:
a latent image forming section configured to form an electrostatic latent image on an image carrier; and
the developing apparatus according to claim 1 configured to supply developing agent for the electrostatic latent image.
